(19) United States
(12) Patent Application Publication
(10) Pub. No.: US 2009/0288543 A1
(43) Pub. Date: Nov. 26, 2009

(54) VARIABLE STRINGED INSTRUMENT

(76) Inventor: Ziv BAR-ILAN, Kibbutz Kiryat Anavim (IL)

Correspondence Address: Pearl Cohen Zedek Latzer, LLP, 1500 Broadway, 12th Floor, New York, NY, 10036, US

(21) Appl. No.: 12/124,424

(22) Filed: May 21, 2008

(51) Int. Cl. G10D 3/00

(52) U.S. Cl. 84/290

(57) ABSTRACT

A stringed musical instrument having a profile to which may be removably attached one or more components at various positions on the profile so that instruments of various scales may be configured on the profile.

### FIELD OF THE INVENTION

The present invention relates generally to stringed musical instruments, and particularly to a stringed instrument with variable or adjustable components and a variable or adjustable scale.

### BACKGROUND OF THE INVENTION

Modular structures or components that can be attached to and removed from a stringed instrument are known. These structures or components however are limited in the position that they may assume on the instrument and in the compatibility of their attachment mechanisms to the instrument. These and other limitations may limit the adjustments and changes that may be made to a stringed instrument by way of an attachment, detachment or change in a position of a component on the instrument.

### SUMMARY OF THE INVENTION

A demonstrative embodiment of the invention may include a stringed musical instrument including a profile and components. The profile may have a profile attachment groove along its length which may be able to accept in several locations on the profile, a component attachment device of any of several components. Components may be attached and detached from the profile. In some embodiments, the profile may have a female connector such as a recessed track or groove along its length and the component may have a male connector, such as a bolt or screw or other extension piece. The track or groove may be suitable for accepting a nut or other fastener into which the male connector may be screwed. The nut may be inserted into or removed from the track or groove at any of several mid-points along the track.

In some embodiments, the profile may have several sides, and some or each of such sides may have a connector groove.

In some embodiments, the components may include for example a nut, a tuning peg, a finger board, a pickup and a bridge.

In some embodiments, the profile has an angled head stock.

In some embodiments, the attachment of a first component to the profile may be hierarchically independent from an attachment of other components to the profile so that a component may be attached or detached from a profile independent of an attachment or detachment of another component.

In some embodiments, components may include a machine head bracket that may hold for example two removable tuning keys—one on each end of the bracket. The bracket may include a rotation stopping edge to limit the rotation of the key within the bracket.

In some embodiments, the connector of components may be of a standard size and dimension, and may include a screw that may be rotated into a bolt that may be fitted into a track or groove.

In some embodiments, the profile includes a power conduit.

Embodiments of the invention may include a method of varying a scale of a stringed musical instrument by moving a bridge or a nut from a first position on the profile to a second position on the profile. In some embodiments, the method may include moving a pickup on the profile from a first position to a second position. In some embodiments, the scales may correspond to a scale of any of a bass, a cello, a double bass, a santur, a qanun, a guitar, a viola, a violin and a fiddle.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIGS. 1A, 1B and 1C are views of a profile in accordance with an embodiment of the invention;

FIGS. 2A, 2B and 2C are views of a bridge and tail piece component in accordance with an embodiment of the invention;

FIGS. 3A, 3B, 3C, 3D and 3E are views of a tuning peg bracket in accordance with an embodiment of the invention;

FIGS. 4A and 4B are views of a fingerboard as may be attached to a profile in accordance with an embodiment of the invention;

FIGS. 5A and 5B are views of a shell or body frame as may be attached to a profile in accordance with an embodiment of the invention;

FIG. 6 is a diagram of a profile with components attached, in accordance with an embodiment of the invention;

FIG. 7 is a diagram of a profile to which is attached a touch pad in accordance with an embodiment of the invention;

FIG. 8 is a diagram of a series of profiles joined to create a santur in accordance with an embodiment of the invention;

FIGS. 9A, 9B, 9C, 9D, 9E and 9F are diagrams of configurations that may be assembled on a profile in accordance with an embodiment of the invention.

FIGS. 10A, 10B and 10C are views of a profile in accordance with an embodiment of the invention;

FIGS. 11A, 11B and 11C are views of a thumb lock fastener in accordance with an embodiment of the invention;

FIGS. 12A, 12B and 12C are diagrams of a parallel profile fastener in accordance with an embodiment of the invention;

FIGS. 13A, 13B, 13C and 13D are views of a shell or body frame as may be attached to a profile in accordance with an embodiment of the invention;

FIG. 14 is a diagram of a finger board assembly in accordance with an embodiment of the invention;

FIGS. 15A and 15B are diagrams of a profile to which is attached a control console in accordance with an embodiment of the invention; and

FIGS. 16A, 16B, 16C and 16D are diagrams of a base plate and of a profile through which an electric wire may be strung in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

In addition to its regular meaning, the term ‘scale’ as used in this document may refer to a length or distance over which a string of an instrument resonates, or the distance between the bridge and the nut of a stringed instrument.

In some embodiments, the profile may be provided such that the user may easily adjust the components on the profile in order to create a variety of instruments. For example, a user may easily change a guitar into a bass or a cello. In some embodiments, components of the instrument may be attached directly to the profile. Dependent hierarchies may thereby be avoided, allowing attachment or detachment of components independent of a placement of other components.

In some embodiments, the components to be added to the profile are modular and therefore, the cost of the components and the cost associated with the modification and addition of these components to the profile may be significantly reduced.

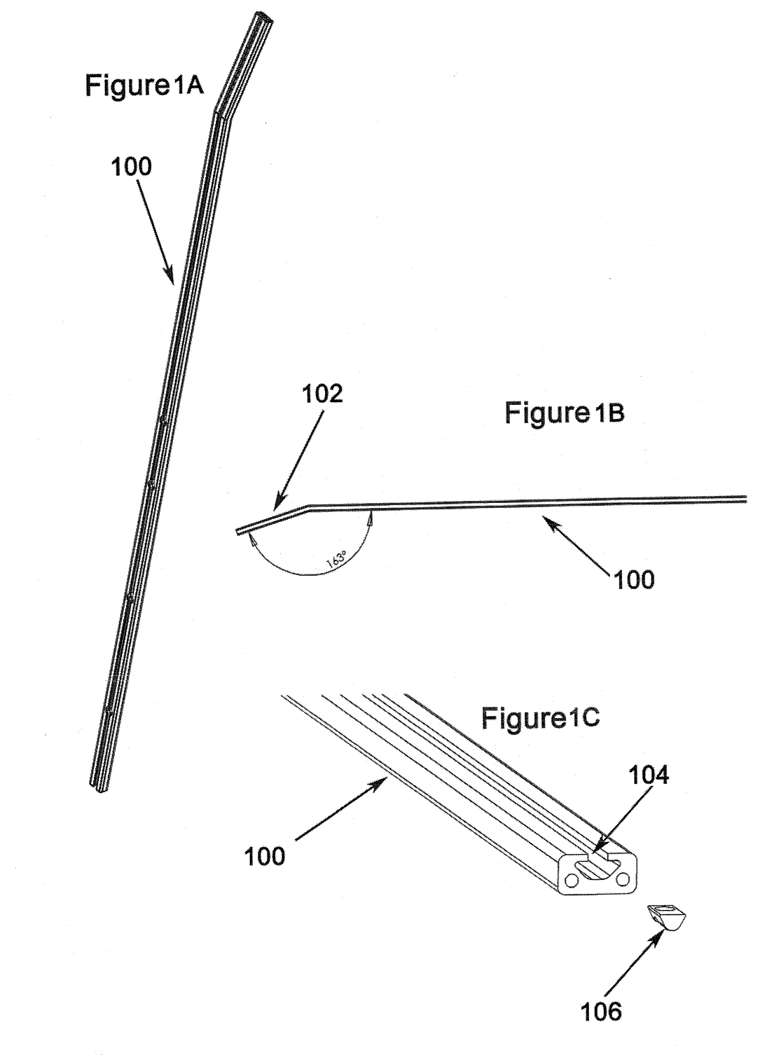

Reference is made to FIG. 1A, an angled view of a profile in accordance with an embodiment of the invention. In some embodiments, a profile 100 may be made of or include a hardened metal or alloy such as for example extruded aluminum. Other materials may be used. Reference is made to FIG. 1B, a side view of profile 100 in accordance with an embodiment of the invention. In some embodiments, a headstock 102 of profile 100 may be angled from a top of profile 100 at approximately 163° from the vertical line of the rest of profile 100. Other angles are possible including a straight profile.

In some embodiments, a length of a straight body of profile 100 may be 888 mm, and a length of headstock 102 may be approximately 122 mm, though other lengths of from approximately 1 meter to approximately 3 meters or even 6 meters are possible. In some embodiments, profile 100 may weigh approximately 0.35 Kg/meter, though other weights are possible. In some embodiments two or more profiles may be attached together, for example back-to-back or otherwise to strengthen the profile against possible bending from tightening of strings.

Reference is made to FIG. 1C, a view of a bottom end of profile 100 and a profile attachment member in accordance with an embodiment of the invention. In some embodiments, a profile attachment member may be or include a female member such as for example groove 104 that may run some or all of the length of profile 100. Groove 104 may be suitable for holding a slot nut 106, that may be inserted for example into groove 104 at any of several points along a length or mid-point of profile 100 or at one of the two ends of profile 100, such that the slot nut 106 holds components to the profile 100. Slot nut 106 which may be used to secure a component in place on profile 100 may be inserted or removed at any of several points on profile 100 so that a particular component may be attached or detached from profile 100 independently and without removing or detaching other components.

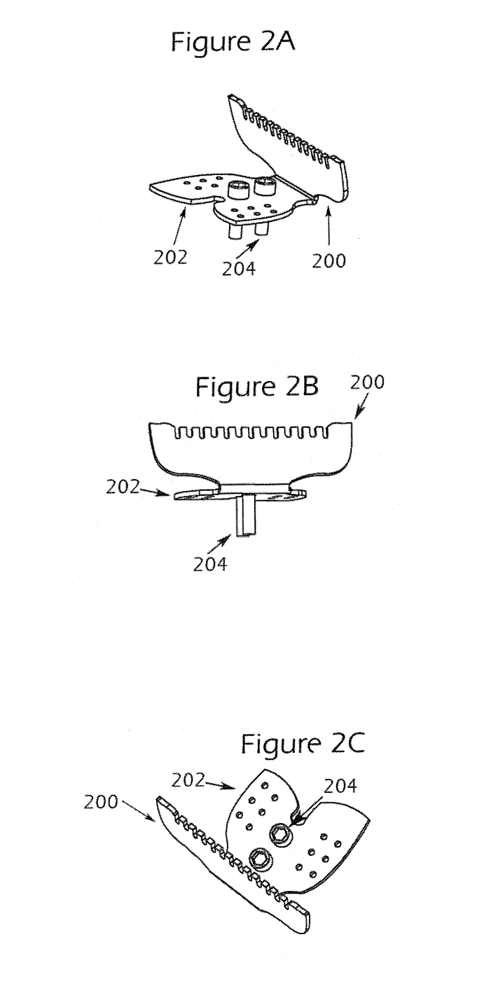

Reference is made to FIGS. 2A, 2B and 2C, views of a bridge and tail piece components in accordance with an embodiment of the invention. In some embodiments, bridge 200 may be combined in a single component with tail piece 202. The component may include a component attachment member such as for example a screw or screw casing 204 into which may be inserted a screw or other male member that may be inserted into groove 104 of profile 100. Screw casing 204 may assume a fixed position in bridge 200 or may assumed one of several positions in an oblong cut-out length of the component into which a screw or screw casing 204 may be inserted. In some embodiments one screw casing 204 may be built into bridge 200, while two or more screw casings 204 may also be used. In some embodiments, a screw, such as a screw having a hex head may be inserted into screw casing 204, and joined to nut 106 that may be inserted and positioned in groove 104 at a desired distance from other components that may be likewise be attached to profile 100. In some embodiments, the attachment or removal of a component from profile 100 may entail the placement of the component at a designated position on the profile 100, insertion of a nut 106 into groove 104 at a point, inserting a screw into screw casing 204, and rotating the screw into nut 106 to tighten the attachment. In some embodiments, a screw casing 204 may not be needed. In some embodiments, a screw may be attached to profile 100, and tightened by a twist action of a thumb peg which may lock a screw into place on the profile such that no tools are needed to attach and detach a component.

In some embodiments, bridge 200 may assume a variety of shapes such as curved or flat, and may accommodate several strings such as 4, 6, 8, 12 or more. Bridge 200 may be removed and replaced with other bridges 200.

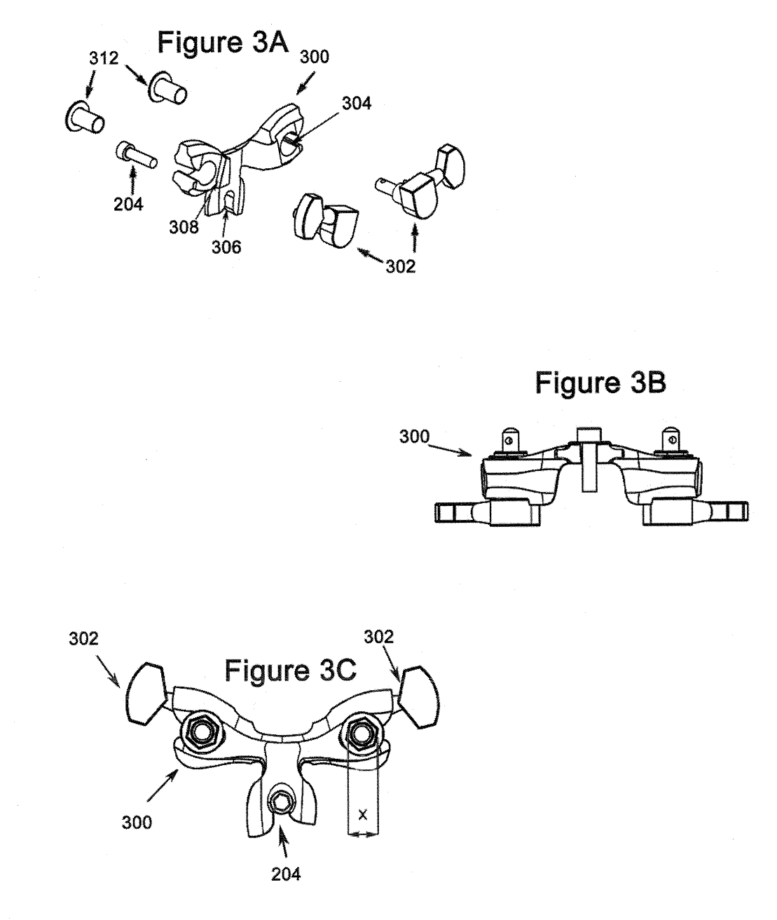

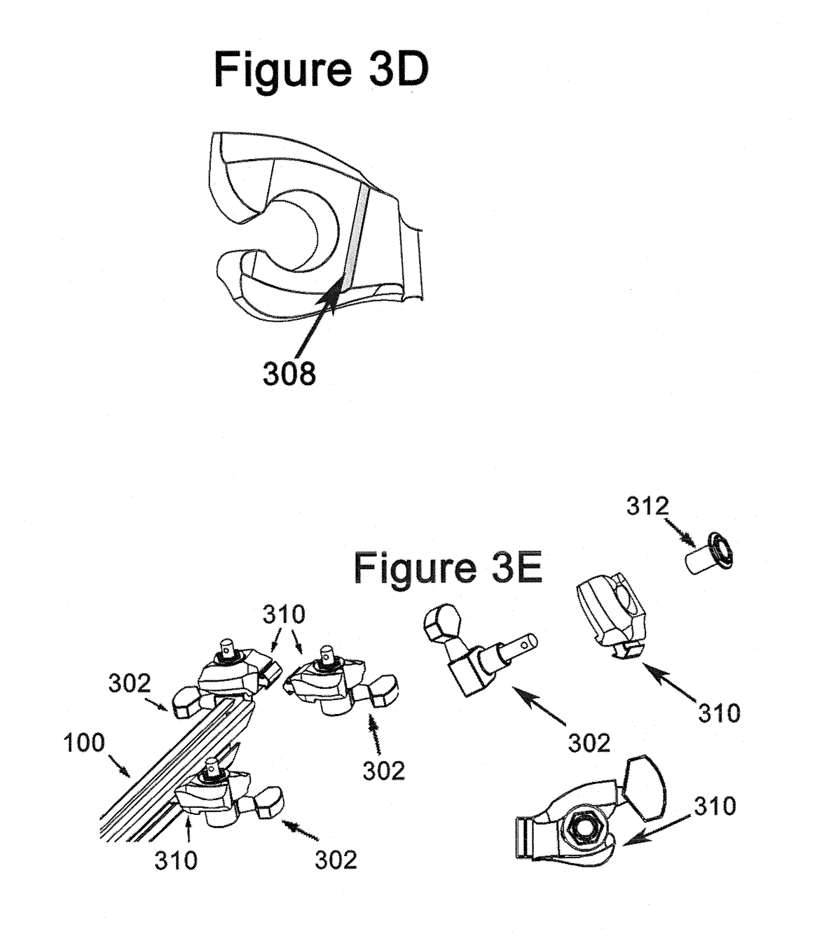

Reference is made to FIGS. 3A, 3B, 3C, 3D and 3E views of a tuning peg bracket in accordance with an embodiment of the invention. In some embodiments, a tuning peg bracket 300 may accept one or two tuning heads 302 that may be used to secure and tune a string for the instrument. A middle area of the bracket 300 may accept a screw, screw casing 204 or other male member that may be inserted into groove 104 of profile 100. In some embodiments, from one to six or more brackets 300 may be secured onto profile 100 so that from 2-12 or more strings may be added to the stringed instrument. Bracket 300 may be fashioned of for example sand-casted aluminum, though other materials and processes may be used. In some embodiments, one or more sockets 304 in bracket 300 may accept and hold a tuning head 302. In some embodiments, tuning key bolt 312 may be used to secure tuning head 302 to bracket 300.

Referring to FIG. 3D, in some embodiments, a ridge of a socket 304 may include a stopper 308 that may prevent a head 302 from rotating past a certain point and reduce or prevent excessive shear pressure that may be exerted by the head 302 upon the bracket 300. In some embodiments, a lower socket 306 may hold a screw or screw casing 204 or other male member that may be used to attach bracket 300 to profile 100. In some embodiments bracket 300 may include one or more heads 302 as part of a single component. The diameter of a socket of a bracket 300, shown as ‘x’ in FIG. 3C may vary to accommodate the instrument configured on the profile. For example, bass tuners may use a 15 mm socket, while guitar tuners may use a 12 mm socket.

Referring to FIG. 3E, in some embodiments, a single tuning peg bracket 310 may be used to secure and tune a single string for the instrument. One may prefer to use a single tuning peg bracket 310 as opposed to tuning peg bracket 300, if one wished to only add or modify a single string on profile 100.

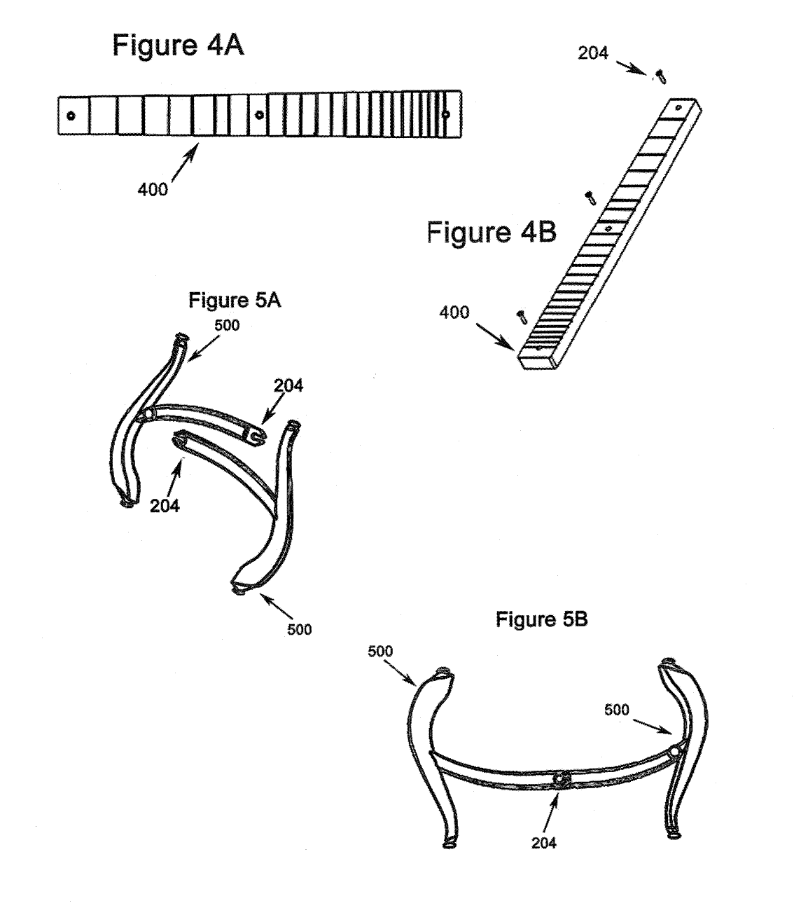

Reference is made to FIG. 4A and FIG. 4B, views of a fingerboard as may be attached to a profile in accordance with an embodiment of the invention. In some embodiments, a fingerboard 400 of a desired length may be attached to profile 100 by way of for example two or more screws or screw casings 204. Fingerboard 400 of a particular length may be removed and replaced with a fingerboard 400 of another length or having other characteristics. For example, a fingerboard 400 may have frets of a particular length, may be rounded or flat or may have other characteristics.

Reference is made to FIGS. 5A and 5B, views of a shell or body frame as may be attached to a profile in accordance with an embodiment of the invention. In some embodiments, one, two or more sides of a body frame shell 500 may linked to each other or attached separately to a profile 100 by for example a central screw or screw casing 204.

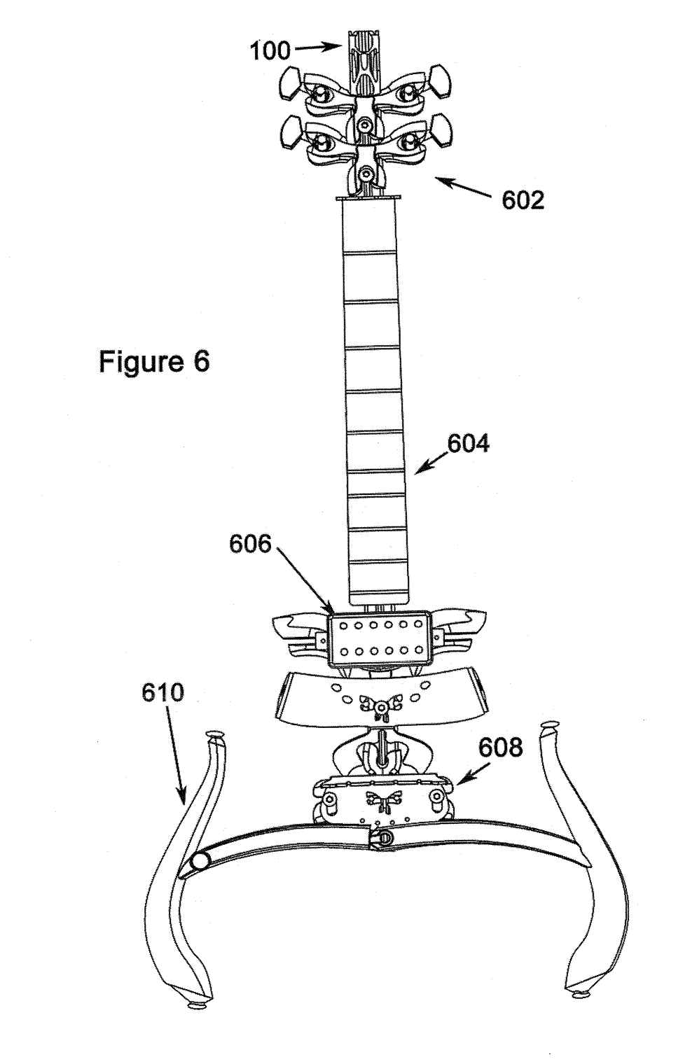

Reference is made to FIG. 6, a diagram of a profile with components attached in accordance with an embodiment of the invention. Components such as tuning peg bracket 602, fingerboard 604, pick-up 606, bridge 608 and shell 610 may be attached to profile 100 by way of for example screw or screw casings 204. A position of these or other components may be adjusted or moved on the profile 100 so that for example a bridge may be moved down the profile 100 to extend the scale of the instrument by extending the distance between bridge 200 and nut 106. Similarly, additional tuning peg brackets 602 may be added to the profile 100 to increase the number of strings on the instrument, and a fingerboard 604 may be replaced with a smaller, larger or different fingerboard 604.

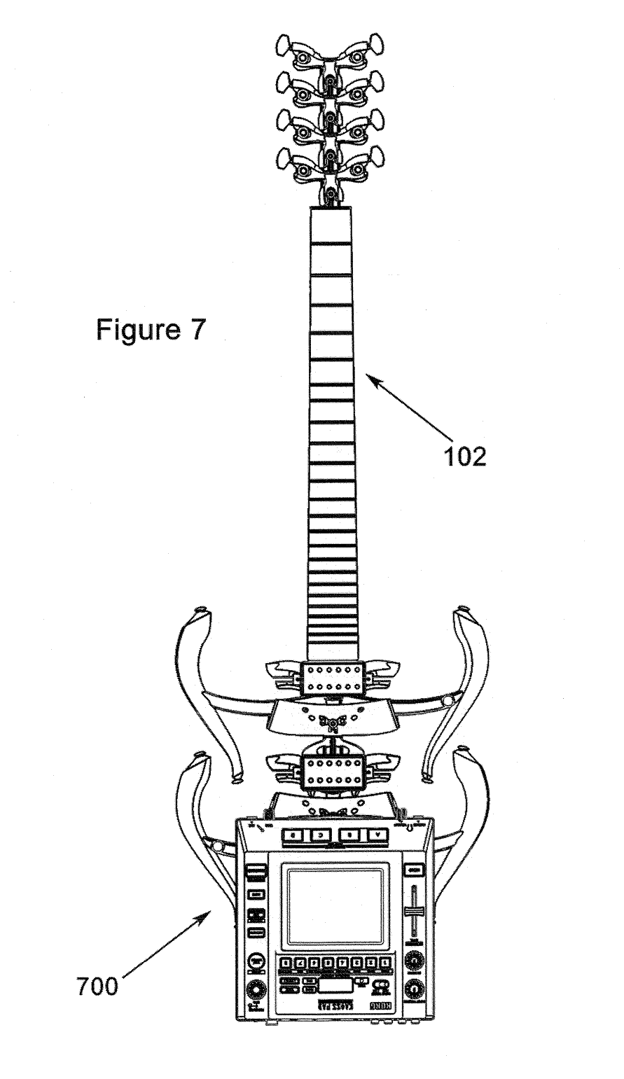

Reference is made to FIG. 7, a diagram of a profile to which is attached a touch pad in accordance with an embodiment of the invention. In some embodiments, electronic effect tools, such as for example a touch pad 700 may be attached to a profile and for example integrated into the instrument 702. In some embodiments, an electronic pad, joy stick or other input device may include for example a wired or wireless transmitter that may be linked to a processor such as a computer, so that a user of instrument 702 may be able to control one or more effects that are controlled by the processor while his hands are still in contact with instrument 702.

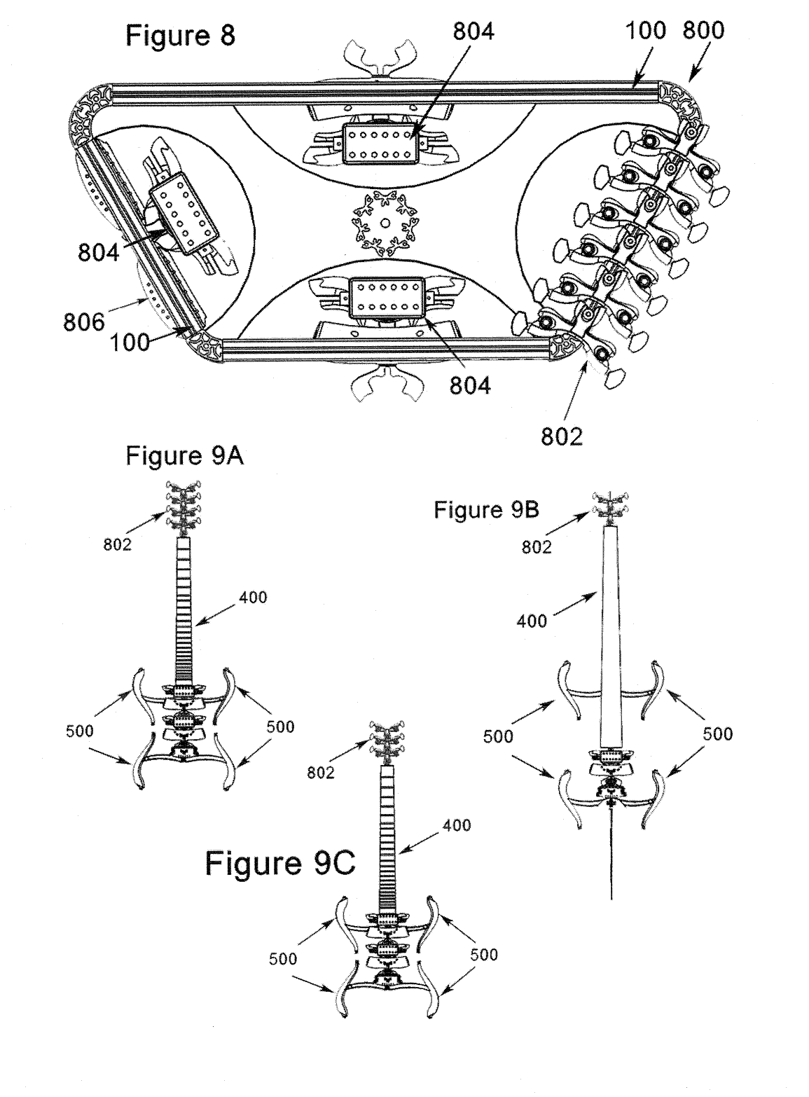

Reference is made to FIG. 8, a diagram of a series of profiles joined to create a santur in accordance with an embodiment of the invention. In some embodiments, curved or other corner pieces 800 may connect two or a series of profiles 100 into assorted shapes such as a trapezoid, square or otherwise, and components such as tuning peg bracket 802, pick-up 804, and bridge 806 may be added at various positions on the profiles 100.

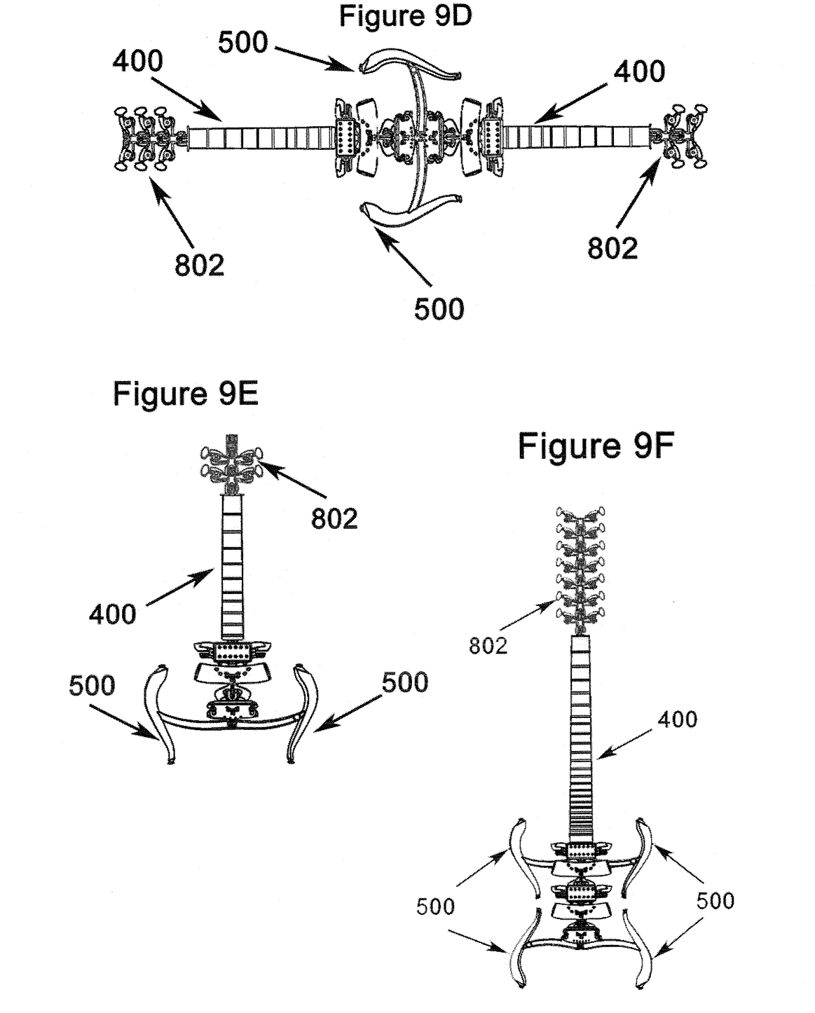

Reference is made to FIGS. 9A, 9B, 9C, 9D, 9E and 9F, diagrams of some of the configurations that may be assembled on a profile in accordance with an embodiment of the invention. In some embodiments, the distance or length between a bridge and a nut may be varied or changed to lengthen a scale. Similarly, a fingerboard may be changed or replaced to accommodate the longer or shorter scale of the instrument. Such alterations may enable a profile 100 to accommodate scales such as those provided by a ukulele, a violin, a viola, a guitar, a cello or a bass. Other scales are possible.

In some embodiments, two or more profiles 100 may be joined for example back-to-back, so that components may be attached to a front profile 100 and to a back profile 100. Such joining may allow a user to add additional components that may still be within reach of a hand or finger while playing an instrument. Other number of profiles 100 may be joined or attached at various angles.

In some embodiments, an attachment or change in a position of a component may be independent of a change in position of any other component. For example, a tuning peg bracket 802 may be added on top of or below other tuning peg brackets 802, without moving or changing a position of such other tuning peg brackets 802. Because a component, such as a tuning peg bracket 802, may be attached directly to the profile 100, the components may remain hierarchically independent of each other, freeing a user to change, add, remove or alter one or more components without a need to alter other components. The attachment of a component directly to a profile rather than to a sub-assembly may create flexibility in the configurations that may be enabled on the profile 100. Similarly, the independent modularity of components and the standard or unified size and configuration of their attachment members may allow new or alternative components to be combined and attached to the profile 100. Other or different benefits may be achieved.

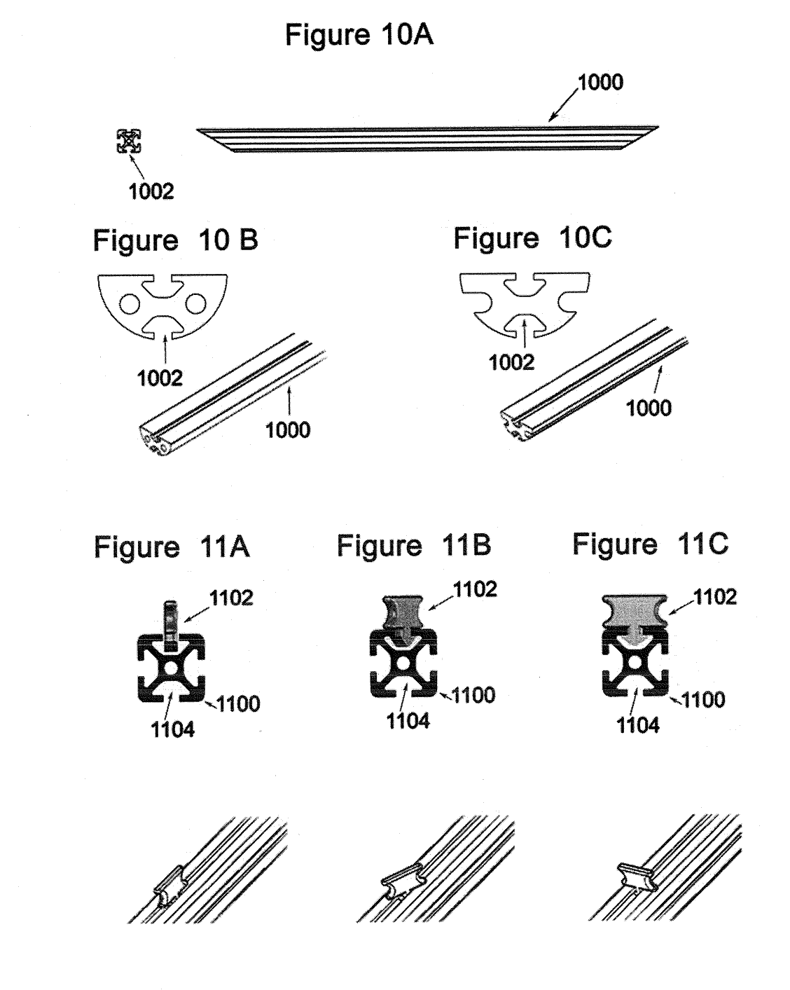

Reference is made to FIGS. 10A, 10B and 10C, views of a profile in accordance with an embodiment of the invention. FIG. 10A illustrates a multi-grooved profile 1000 having grooves 1002 on more than one side. As can be seen, the grooves may be located on some or all of the sides of profile 1000. FIGS. 10B and 10C illustrate a profile having a rounded bottom to allow more comfortable holding by a player. Specifically, FIG. 10B demonstrates a round bottom profile with two grooves and FIG. 10C shows a round bottom profile with four grooves. In some embodiments, various components may be attached to two or more sides of profile 1000 by way of the various grooves 1002 on the several sides. Attaching components to various sides of a profile 1000 may provide easier access to such components by fingers of a player, thereby putting more components within finger-reach of the player.

Reference is made to FIGS. 11A, 11B and 11C, views of a thumb-lock fastener in accordance with an embodiment of the invention. Thumb-lock fastener 1102 may be placed into a groove of profile 1100, such that its long end is parallel to the length of the groove 1104. To secure fastener 1102 to the profile 1100 and lock a component into place, fastener 1102 may be turned so that its long end is perpendicular to the length of groove 1104. Other ways of locking the fastener are possible. The pressure of fastener 1102 against a rim of groove 1104 may hold a component in place on profile 1100. Fastener 1102 may eliminate the need for a tool to attached and detach components from profile 1100.

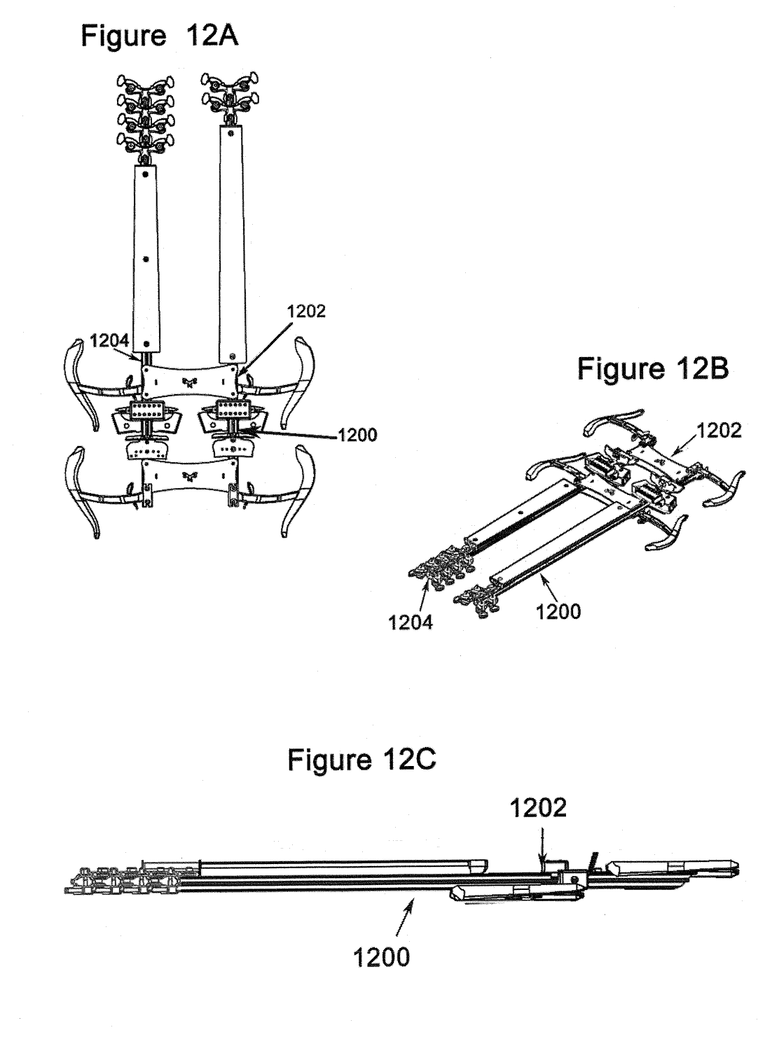

Reference is made to FIGS. 12A, 12B and 12C, diagrams of a parallel profile fastener in accordance with an embodiment of the invention. Profile fastener 1202 may be used to join at least two profiles together side by side. Fastener 1202 may be attached to a first profile 1200 by a screw into a slot nut that may fit into a groove of a first profile. A second side of fastener 1202 may be screwed into a groove of a second profile 1204 so that the two profiles are held in place in parallel to each other. Each of the two profiles 1200 and 1204 may be fitted with strings, bridge, nut and other components, so that each of the two profiles are held together but can be played independently.

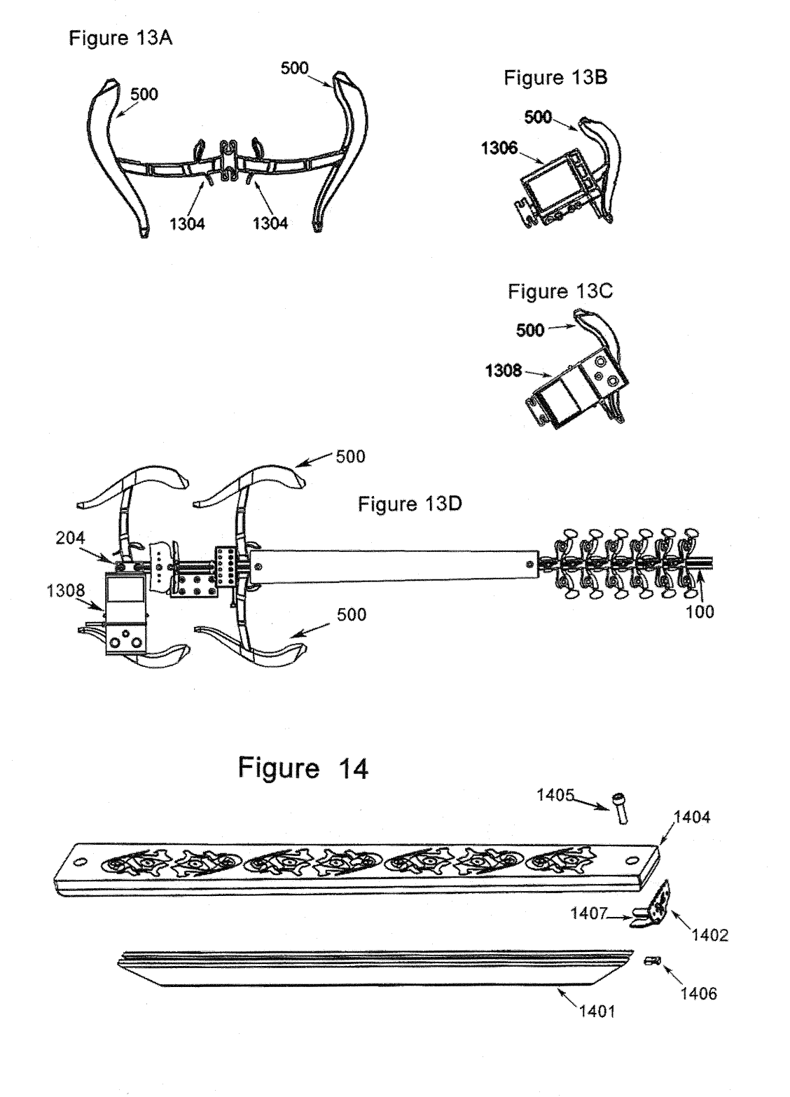

Reference is made to FIGS. 13A, 13B, 13C and 13D, views of a shell or body frame as may be attached to a profile in accordance with an embodiment of the invention. In some embodiments, two or more shell frames 500 may be linked to each other or attached separately to a profile 100 by for example a central screw or screw casing 204, so that the profile may assume a bottom shell that may rest for example on a knee of a player, and a top shell upon which a player may rest an arm. Similarly, the two or more frame shells 500 may provide a cello-like structure upon which a player may rest one or more limbs during play. As shown in FIG. 13A, FIG. 13B and FIG. 13C, in some embodiments, a sound effect console 1306, peddle effect console 1308 or other components may be attached to one or more shell frames 500 to put them at a convenient position to a player. A “horn-shape shelf” 1304, may provide additional support for sound effect console 1306 and peddle effect console 1308.

Reference is made to FIG. 14, a diagram of a finger board assembly in accordance with an embodiment of the invention. As is shown in FIG. 14, a nut 1402 having for example an open ended tail 1407, may be tucked between a finger board 1404 and a profile 1401, and may be secured by for example a same screw that holds the finger board 1404 to profile 1401. Nut 1402 may be replaced by loosening a screw enough so that tail 1407 can be pulled out, and then inserting a different nut. Although FIG. 14 specifically shows the use of a nut, other components may be used, and therefore easily removed without the removal of finger board 1404.

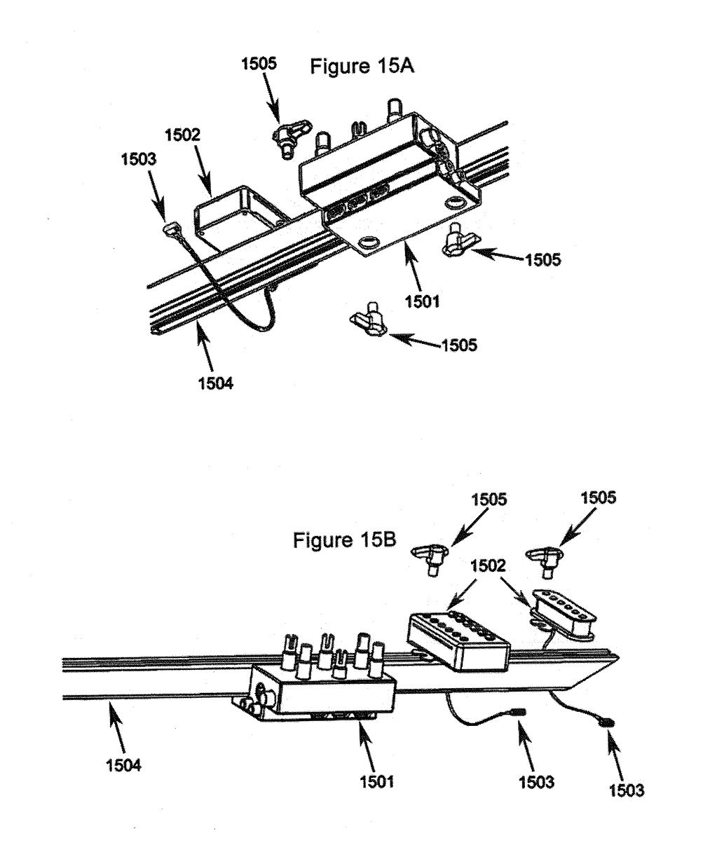

Reference is made to FIGS. 15A and 15B, diagrams of a profile to which is attached a control console in accordance with an embodiment of the invention. An electric control console 1501 that may control pickup 1502 may be attached to the profile, and may output a signal to an amplifier. Pickups 1502 may be connected to console 1501 by an electric wire with a connecting plug 1503 for easy insertion and removal. Console 1501 may be mounted on the profile 1504 and positioned along the profile groove with mounting screws 1505. In some embodiments, control console 1501 may be placed on the underside of profile 1504, for quick and easy access by a player.

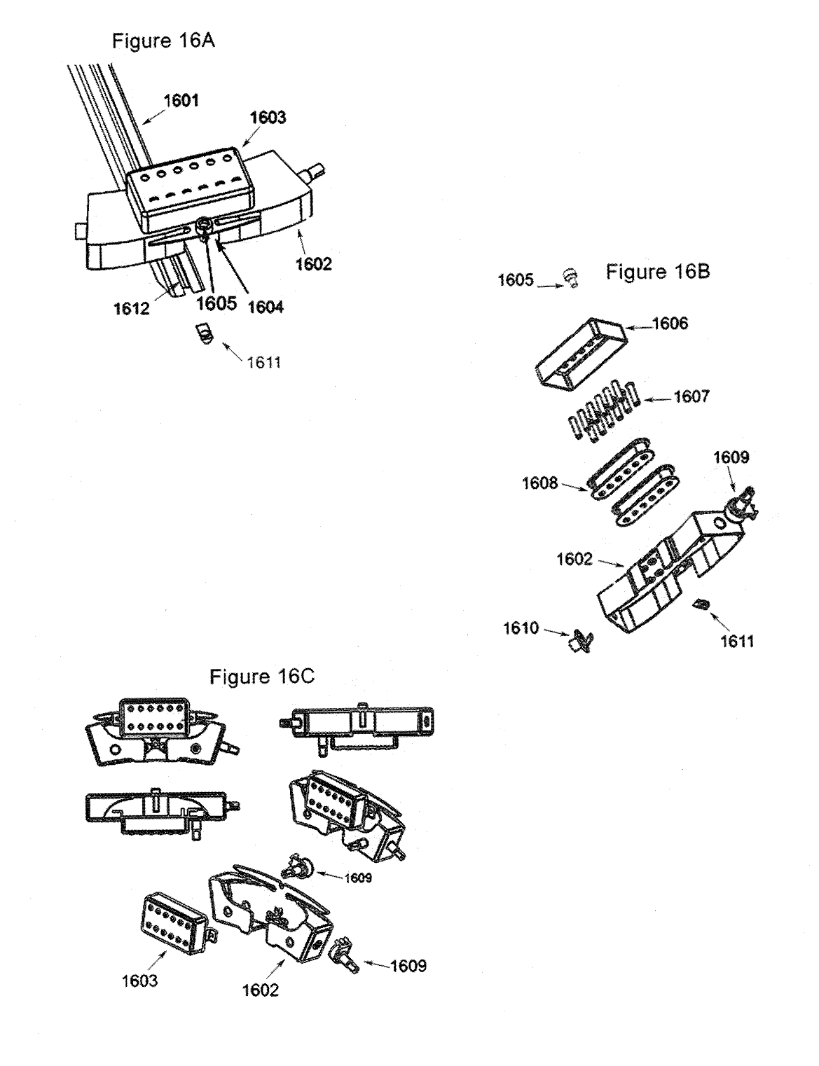

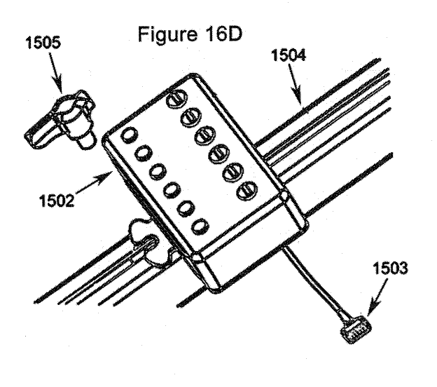

Reference is made to FIGS. 16A, 16B and 16C, illustrate an attachable unified pickup with a control potentiometer 1609, jack output 1610 and mounting base plate 1602. The unified pickup can be positioned and attached directly on the profile independent of a control console, by a mounting screw 1605. FIG. 16A illustrates the assembly of pickup 1603 with a connection of base plate 1602 to profile 1601 by mounting screw 1605 and slot nut 1611. The base plate “tail” 1604, may function as a conductor for the electric wires that may be passed over profile 1601. FIGS. 16B and 16C illustrate the assembly of pickup 1603 to base plate 1602. The components of pickup 1603 may comprise humbucker cover 1606, polepiece slugs and screws 1607, plastic bobbins 1608 and potentiometer 1609. Jack output 1610 may also be attached to base plate 1602. FIG. 16D illustrates the assembly of pickup 1502 with an open tailed base plate providing a quick release and replacement of the pickup to profile 1504 by mounting screw 1505.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

I claim:

1. A stringed musical instrument comprising:
a profile; and
a plurality of components,
said profile comprising a profile attachment member on a length thereof to accept in a plurality of locations on said profile a component attachment member of a first component of said plurality of components, and to accept in a plurality of locations on said profile a component attachment member of a second component of said plurality of components; and
said first of said plurality of components being suitable for attaching to and detaching from said plurality of location on said profile, and said second of said plurality of components being suitable for attaching to and detaching from said plurality of locations on said profile.

2. The instrument as in claim 1, wherein said profile comprises an angled head stock.

3. The instrument as in claim 1, wherein said profile attachment member comprises a female member, and wherein said component attachment member comprises a male member.

4. The instrument as in claim 3, wherein said female member comprises a recessed track along said length.

5. The instrument as in claim 4, wherein said recessed track along said length comprises two overhanging lengthwise rims, where said component attachment member includes a first piece less in diameter than the width of the opening formed by said two overhanging rims and a second piece greater in diameter than said width of said opening.

6. The instrument as in claim 4, wherein said track is suitable for accepting a nut into which said male attachment member may be screwed.

7. The instrument as in claim 5, wherein said nut is suitable for removal from said track from a plurality of mid-points along said track.

8. The instrument as in claim 1, wherein said profile attachment member comprises a first profile attachment member along a first side of said profile, and wherein said profile comprises a second profile attachment member along a second side of said profile.

9. The instrument as in claim 1, wherein said plurality of components are selected from the group consisting of: a nut, a tuning peg, a finger board, a pickup, a body frame shell and a bridge.

10. The instrument as in claim 1, wherein an attachment of said first of said plurality of components to said profile of said instrument is hierarchically independent from an attachment of a remainder of said plurality of components.

11. The instrument as in claim 1, wherein said components include a machine head bracket suitable to hold two removable tuning keys, a first of said two tuning keys on a first side of said bracket, and a second of said two tuning keys on a second side of said bracket.

12. The instrument as in claim 11, wherein said bracket includes a rotation stopping edge to limit a rotation of said key within said bracket.

13. The instrument as in claim 1, wherein a component attachment member of a first of said plurality of components comprises dimensions equal to a component attachment member of a second of said plurality of components and third of said plurality of components.

14. The instrument of claim 1, wherein said component attachment member comprises a shaft suitable for insertion into said profile attachment member, and wherein said shaft is suitable to secure by rotation of said shaft an attachment of said component to said profile.

15. The instrument as in claim 1, wherein said profile comprises a power conduit.

16. A method of varying a scale of a stringed musical instrument comprising moving a nut from a first position on a profile, said first position corresponding to a first scale, to a second position on said profile, said second position corresponding to a second scale.

17. The method as in claim 16, comprising, moving a pickup on said profile from a first position of said pickup on said profile to a second position of said pickup on said profile.

18. The method as in claim 16, wherein said first scale corresponds to a scale selected from a group consisting of: a bass, a cello, a double bass, a santur, a qanun, a guitar, a viola, a violin and a fiddle.

19. A component for a stringed musical instrument, said component comprising an attachment member for directly attaching said component to a profile of said instrument, said member suitable for detaching and reattaching said component to said profile at a plurality of positions on said profile.

20. The component as in claim 19, wherein said component is selected from the group consisting of: a nut, a tuning key, a finger board, a body frame shell, a pickup and a bridge.
